(19) United States
(12) Patent Application Publication
(10) Pub. No.: US 2023/0351517 A1
(43) Pub. Date: Nov. 2, 2023

(54) SYSTEM FOR PREDICTING HEALTHCARE SPEND AND GENERATING FUND USE RECOMMENDATIONS

(71) Applicant: Optum, Inc., Minnetonka, MN (US)

(72) Inventors: Adam Russell, Arlington, MA (US); Thomas C. Linden, Minneapolis, MN (US); Brendan J Moriarity, Mahtomedi, MN (US); Elliot C. Johnson, Burnsville, MN (US); Robert Kahn Rossmiller, Brookfield, WI (US)

(21) Appl. No.: 17/661,671

(22) Filed: May 2, 2022

(51) Int. Cl. G06Q 40/08; G06Q 30/02; G06N 3/08

(52) U.S. Cl. CPC G06Q 40/08; G06Q 30/0204; G06N 3/08

(57) ABSTRACT

This disclosure describes techniques that include a method for estimating healthcare costs, the method comprising applying, by a computing system, a machine learning (ML) model to a user subgraph of a current user to generate an estimated healthcare cost of the current user for a future time period, wherein the user subgraph of the current user is graph data comprising nodes and edges that represent information associated with medical care of the current user; and generating, by the computing system, a user interface including a budget for the future time period that includes the estimated healthcare cost and a list of selectable medical expense categories, wherein each of the selectable medical expense categories includes an associated cost.

### BACKGROUND

Healthcare consumers have a number of options for managing their medical spending. One option is to set aside funds in a tax-favorable Flexible Spending Account (FSA) and/or a Health Spending Accounts (HSA). These are restricted pre-tax funds that may be used only to cover medical expenses. Consumers must make allocation decisions during an annual open enrollment period in order to contribute to these accounts. If the allocations to these funds are too small, the consumer risks not receiving the full tax benefit for money set aside for medical spending. The consumer risks losing unspent money if the allocations are too large.

### SUMMARY

In general, techniques are described for estimating healthcare costs by a computing system. The computing system applies a machine learning (ML) model to a user subgraph of a user to generate an estimated healthcare cost, such as an estimated out of pocket healthcare cost for the user during a future time period. The computing system generates a user interface to display a healthcare budget including the estimated healthcare cost on a user device. The user subgraph includes nodes and edges that represent information associated with medical care of the user. The user interface may include a list of selectable medical expense categories where each category may include an associated cost and a rank based on factors such as importance of the category to health and wellbeing and cost analysis (e.g., average costs based on region). In one example, the computing system may determine whether the budget is enough based on the estimated healthcare cost and a selected set of medical expense categories. The computing system may further determine which of the set of medical expense categories are covered by the budget. In some examples, the computing system may receive an indication from a user to increase or decrease the budget. In response, the computing system may further generate subsets of the selectable medical expense categories that satisfy the increased or decreased budget.

In one aspect, this disclosure describes a method comprising: applying, by a computing system, a machine learning (ML) model to a user subgraph of a current user to generate an estimated healthcare cost of the current user for a future time period, wherein the user subgraph of the current user is graph data comprising nodes and edges that represent information associated with medical care of the current user; and generating, by the computing system, a user interface including a budget for the future time period that includes the estimated healthcare cost and a list of selectable medical expense categories, wherein each of the selectable medical expense categories includes an associated cost.

In another aspect, this disclosure describes a computing system comprising: a storage device; and processing circuitry having access to the storage device and configured to: apply a machine learning (ML) model to a user subgraph of a current user to generate an estimated healthcare cost of the current user for a future time period, wherein the user subgraph of the current user is graph data comprising nodes and edges that represent information associated with medical care of the current user; and generate a user interface including a budget for the future time period that includes the estimated healthcare cost and a list of selectable medical expense categories, wherein each of the selectable medical expense categories includes an associated cost.

In another aspect, this disclosure describes a non-transitory computer-readable storage medium comprising instructions that, when executed, cause processing circuitry of a computing system to: apply a machine learning (ML) model to user subgraph of a current user to generate an estimated healthcare cost of the current user for a future time period, wherein the user subgraph of the current user is graph data comprising nodes and edges that represent information associated with medical care of the current user; and generate a user interface including a budget for the future time period that includes the estimated healthcare cost and a list of selectable medical expense categories, wherein each of the selectable medical expense categories includes an associated cost.

The details of one or more aspects of the disclosure are set forth in the accompanying drawings and the description below. Other features, objects, and advantages of the techniques described in this disclosure will be apparent from the description, drawings, and claims.

### BRIEF DESCRIPTION OF THE DRAWINGS

FIG. 1 is a block diagram illustrating an example computing system in accordance with one or more aspects of this disclosure.

FIG. 2 illustrates an example of a user subgraph in accordance with one or more aspects of this disclosure.

FIG. 3 is a block diagram illustrating an example provider computing system for generating an estimated healthcare cost, in accordance with techniques of the disclosure.

FIGS. 4A-4C illustrate an example user interface generated for display on a user device.

FIG. 5 is an example of training a machine learning system to generate an estimated healthcare cost in accordance with techniques of the disclosure.

FIG. 6 is a flow diagram illustrating example operations performed by a provider computing system in accordance with one or more aspects of the present disclosure.

### DETAILED DESCRIPTION

Healthcare organizations are comprised of members that rely in part on the healthcare organizations to help the members manage their healthcare benefits. For example, members must make allocation decisions during an annual open enrollment period in order to contribute to a Flexible Spending Account (FSA) and/or a Health Spending Account (HSA). The amount allocated by the member includes a risk of not having the full benefit of tax advantaged money for medical spending if allocations are too small or losing unspent money if allocations are too large. Thus, the problem is how to most accurately estimate the amount of money to save in any given year in an FSA and/or HSA.

This disclosure describes techniques for applying a machine learning (ML) model to a user subgraph to generate an estimated healthcare cost of a user for a future time period. The estimated healthcare cost may be an out of pocket healthcare cost for a user based on what a user may owe after insurance. The user subgraph of the user is graph data comprising nodes and edges that represent information associated with medical care of the current user. Applying the ML model to user subgraphs may yield performance advantages, e.g., in terms of processing time, by maintaining the information about the medical care of the user as graph data instead of converting it to other formats. Graph data may be an especially efficient way of storing information about medical care of multiple users, e.g., because a single node can provide information with respect to the medical care of multiple users. Another example benefit is the consideration of a multitude of medical and financial aspects that may not be considered by the member during open enrollment. For example, future expenses such as for vision, dental, and prescriptions and procedures associated with past member healthcare interactions. In contrast, conventional systems merely provide an estimate based on a prior year or average of prior years, or do not provide any estimate. Additionally, the healthcare provider system may provide a benefit of flexibility by allowing for a member to add additional budget for expenses that may not be predictable by the ML model, such as maternity expenses. Another example benefit of the healthcare provider system includes generating subgroups of different combinations of prioritized medical expenses based on the total budget. In one example, the total budget includes the ML models estimated budget and any additional expenses added by the member. Thus, aspects of this disclosure may be used to assist a member in determining the most appropriate amount of money to allocate for medical spending for a future time period.

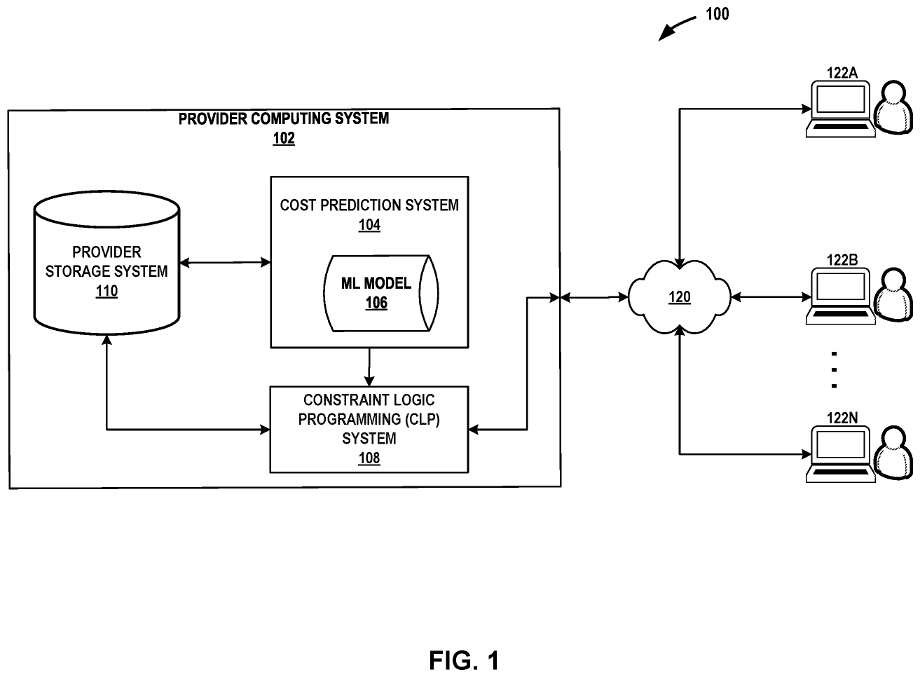

FIG. 1 is a block diagram illustrating an example computing system 100 in accordance with one or more aspects of this disclosure. In the example of FIG. 1, computing system 100 includes a provider computing system 102, user devices 122A, 122B, through 122N (collectively, “user devices 122”), each connected to provider computing system 102 by a network 120. Provider computing system 102 may be operated by a healthcare organization comprising a multitude of members. In the example of FIG. 1, provider computing system 102 may provide a portal for members to manage and access their respective healthcare benefits, such as open enrollment, through user devices 122.

In the example of FIG. 1, provider computing system 102 includes a cost prediction system 104 that includes a machine learning (ML) model 106, constraint logic programming (CLP) system 108, and a provider storage system 110. In some examples, computing system 100 may include additional subscriber device systems and/or one or more additional computing systems. In examples where provider computing system 102 includes two or more computing devices, the computing devices of provider computing system 102 may act together as a system. Example types of computing devices include edge appliances, hubs, cloud-based servers, other server devices, personal computers, handheld computers, intermediate network devices, data storage devices, and so on. In examples where provider computing system 102 includes two or more computing devices, the computing devices of provider computing system 102 may be geographically distributed or concentrated together (e.g., on the premises of the environment or in a single data center).

In some examples, user devices 122 may be implemented as any suitable client computing system, such as a mobile, non-mobile, wearable, and/or non-wearable computing device. Each of user devices 122 may represent a smart phone, a tablet computer, a computerized watch, a personal digital assistant, a virtual assistant, a gaming system, a media player, an e-book reader, a television or television platform, a laptop or notebook computer, a desktop computer, a camera, or any other type of wearable, non-wearable, mobile, or non-mobile computing device that may perform operations in accordance with one or more aspects of the present disclosure.

Network 120 is a communications network that may provide communication between provider computing system 102 and user devices 122. Network 120 may represent or include one or more of an optical network, a cellular network, the Internet, a Local Area Network (LAN), Wide Area Network (WAN), satellite link, fiber network, cable network, or a combination of these and/or others.

Provider storage system 110 of provider computing system 102 may store various types of data. For example, provider storage system 110 may include a healthcare graph, user subgraphs, and training data (e.g., subgraph training datasets). Graph data is a non-linear data structure consisting of nodes (e.g., members, hospitals, medical claims, etc.) and edges (connections between nodes). The nodes are sometimes referred to as vertices and the edges are lines or arcs that connect any two nodes in the graph. The healthcare graph comprises nodes and edges that represent information related to healthcare of multiple users.

A graph traversal or graph search refers to the process of visiting each vertex in a graph to change or update the graph, or to return a subgraph. Provider computing system 102 may traverse a healthcare graph of a population of users stored in provider storage system 110 to generate a user subgraph corresponding to a current user of computing system 100. The user subgraph of the current user is graph data comprising nodes and edges that represent information associated with medical care of the current user.

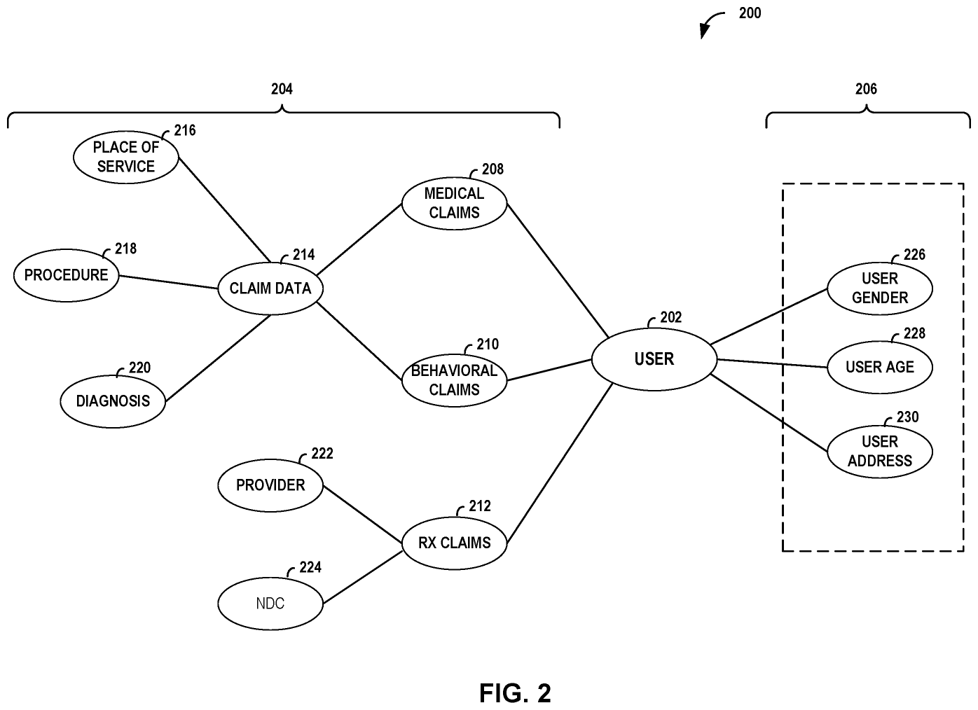

FIG. 2 illustrates an example of a user subgraph 200 in accordance with one or more aspects of this disclosure. User subgraph 200 includes medical information 204 and demographic information 206, where each item (oval) in the graph is a node and each connection (line) between the nodes is an edge. In the example of FIG. 2, medical information 204 is a first portion of user subgraph 200 and demographic information 206 is a second portion of user subgraph 200. The nodes and edges may represent various relationships between activities and items associated with a user's medical costs, such as claim types like medical claims 208, behavioral claims 210, and prescription claims 212. Some claim types (nodes) may be connected to claim data, such as claim data node 214 that is further connected to other nodes such as place of service node 216, procedure node 218, and diagnosis node 220. Other nodes may include additional relationships or connection to other nodes, for example, the prescription claim node 212 may be connected to a provider node 222 and drug information node 224 (e.g., nation drug code (NDC)). Demographic information 206 may include additional nodes connected to user node 202, such as gender node 226, user age node 228, and user address node 230.

Returning to FIG. 1, in one example, provider computing system 102 determines a medical health cost estimate by applying ML models 106 to the user subgraph of the current user (e.g., member using user device 122A) to generate an estimated healthcare cost of the current user for a future time period. The future time period may be one month, one quarter year, one years, multiple years, or another time period. The estimated healthcare cost may be a user's out of pocket healthcare cost based on the user's insurance benefit. Computing system 100 (e.g., user device 122A or provider computing system 102) may generate a user interface including a budget for the future time period that includes the estimated healthcare cost. The user interface may also include a list of selectable medical expense categories. Examples of a user interface provided to user devices 122 may include webpage data, data associated with a native application on user devices 122, or other data suitable for display on user devices 122. Each of the selectable medical expense categories may include an associated cost and a rank based on factors such as importance of the category to health and wellbeing of the user and cost analysis. For example, the cost in a category may be dynamically generated by CLP system 108 based on an average or other statistical function applied to costs on a per health referral region basis. In another example, the cost in a category may be a static figure based on region or other parameters, such as an amount obtained through a look up table in provider storage system 110.

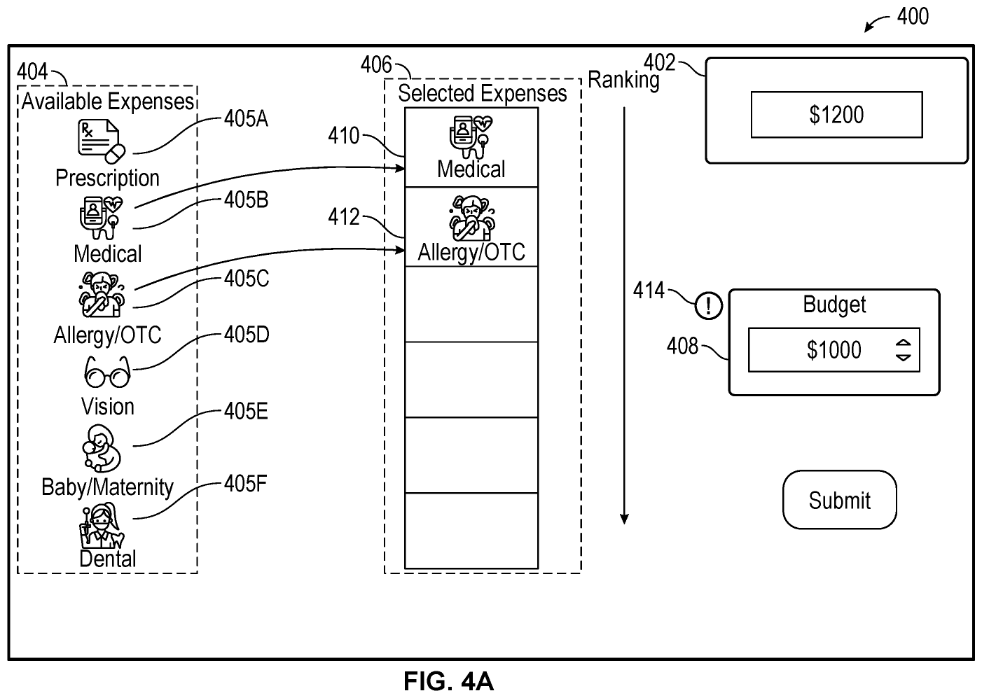

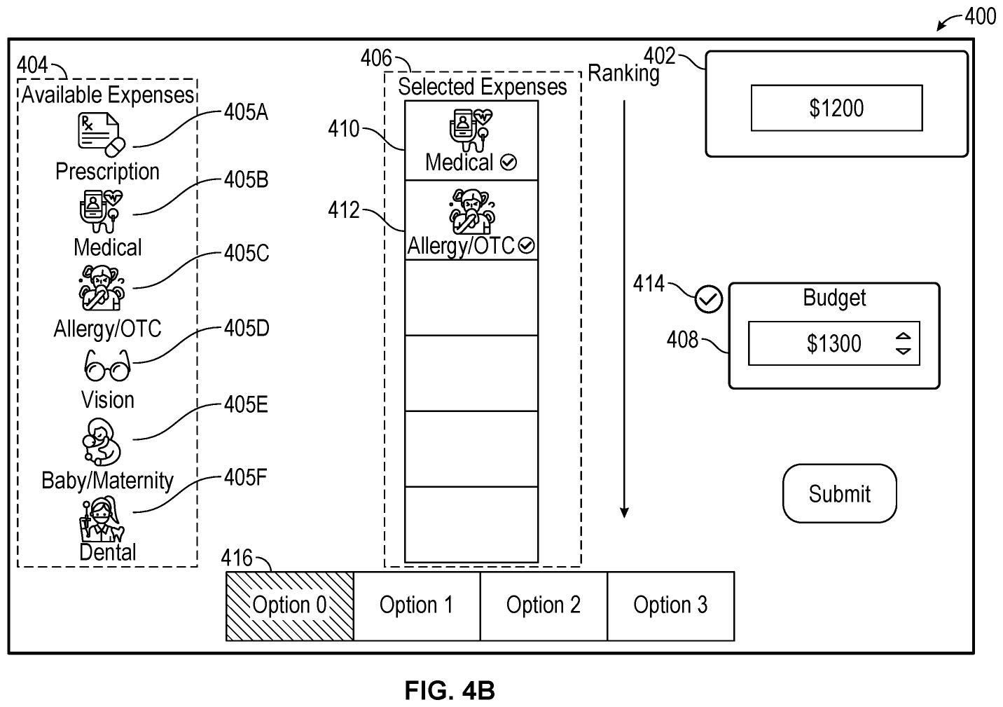

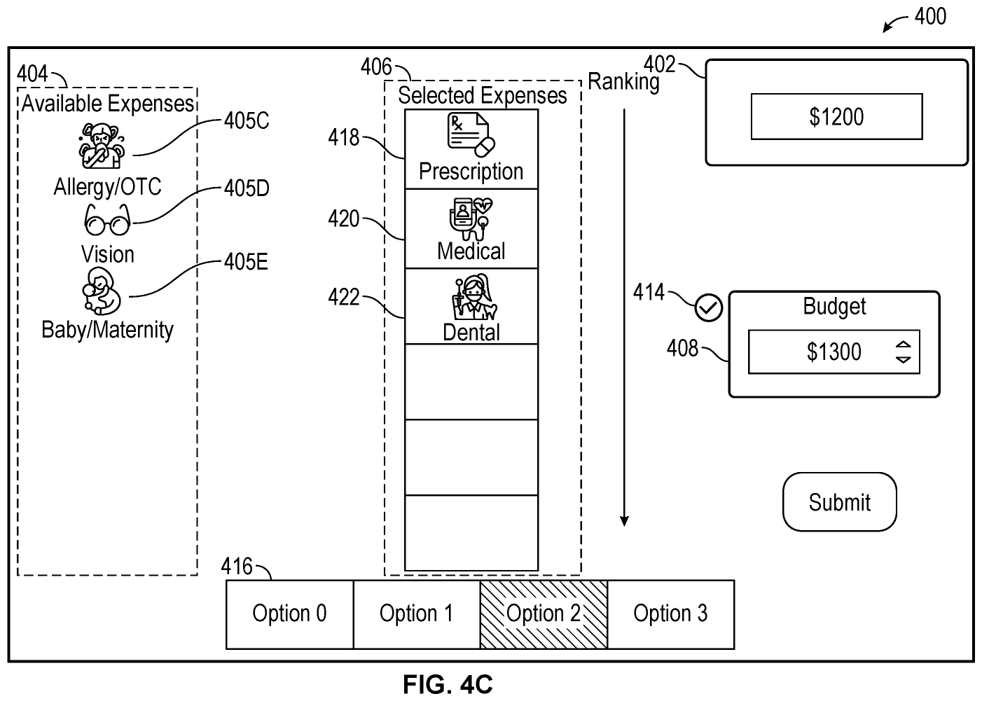

In one example, computing system 100 (e.g., user device 122A or provider computing system 102) may receive an indication of user input that indicates which of the selected medical expense categories are most important to fund with the budget. In response, computing system 100 may determine if the selected expenditure categories are within the budget that includes the estimated healthcare cost generated by ML model 106. In another example, computing system 100 may receive an indication of user input to increase or decrease to the budget through user device 122A. In response to the updated budget data, computing system 100 may use CLP system 108 to generate one or more subsets of the medical expense categories that are within the updated budget, as discussed in further detail below with respect to FIGS. 4A-C.

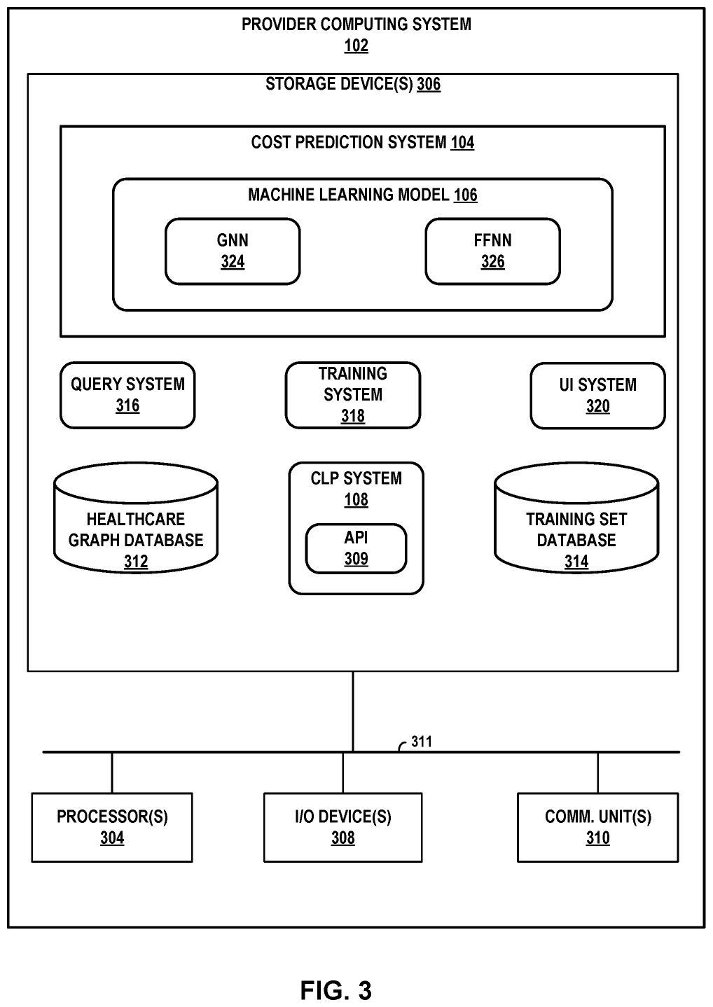

FIG. 3 is a block diagram illustrating example a provider computing system 102 for generating an estimated healthcare cost, in accordance with techniques of the disclosure. Provider computing system 102 may generate information (e.g., estimated out of pocket healthcare cost, medical expense options, etc.) in the form of an interactive user interface for output on a display at a user device (e.g., user devices 122). The interactive user interface may be associated with functionality provided by provider computing system 102. Such user interfaces may be associated with computing platforms, operating systems, applications, and/or services executing at or accessible from provider computing system 102. For example, user device 122A of FIG. 1 may receive and present one or more user interfaces generated by provider computing system 102. In one example, the one or more user interfaces are graphical user interfaces of application(s) executing at user device 122A and include various interactive and non-interactive graphical elements displayed at various locations of user device 122A, such as text boxes, check boxes, ring menus, etc. Although illustrated with respect to user device 122A, the user interface may be displayed on a display (not shown) of provider computing system 102.

In various examples, components and systems illustrated in provider computing system 102 of FIG. 3 for generating an estimated healthcare cost and a user interface, as illustrated in FIGS. 4A-4C, may be implemented, in whole or in part, by provider computing system 102 and/or user device 122A of FIG. 1. As shown in the example of FIG. 3, provider computing system 102 includes one or more processor(s) 304, storage device(s) 306, input/output (I/O) device(s) 308, communication unit(s) 310, and one or more communication channels 311.

Provider computing system 102 may include other components. For example, I/O devices 308 of provider computing system 102 may include various input and output devices, such as display screens, touch sensitive screens, keyboards, and so on. Communication channel(s) 311 may interconnect physically, communicatively, and/or operatively with each of component of provider computer system 102. In some examples, communication channel(s) 311 may include one or combination of a system bus, a network connection, an inter-process communication data structure, or any other method for communicating data between components.

Processor(s) 304 of provider computing system 102 comprise circuitry configured to perform processing functions that may read and write data and execute instructions stored by storage device(s) 306, such as execution of a query system 316, a training system 318, cost prediction system 104, constraint logic programming (CLP) system 108, and a user interface (UI) system 320, to generate an estimated healthcare cost and an interactive user interface for display on user devices, such as user devices 122. Processor(s) 304 may be one or more microprocessors, Application Specific Integrated Circuits (ASICs), Field Programmable Gate Arrays (FPGAs), or other types of processing circuit that may be configured to implement the functionality as described herein in accordance with techniques of the disclosure.

Communication unit(s) 310 may enable provider computing system 102 to send data to and receive data from one or more other computing devices, such as user devices 122 of FIG. 1 or other local or remote computing and storage devices. Provider computing system 102 may also use communication unit(s) 310 to communicate with one or more other computing devices or systems, such communicating estimated medical costs via a user interface to user devices 122. In some examples, communication unit(s) 310 may include wireless transmitters and receivers that enable provider computing system 102 to communicate wirelessly with other computing devices. Examples of communication unit(s) 310 may include network interface cards, Ethernet cards, optical transceivers, radio frequency transceivers, or other types of devices that are able to send and receive information. Other examples of such communication units may include BLUETOOTH™, 3G, 4G, 5G, and WI-FI™ radios, Universal Serial Bus (USB) interfaces, etc.

Storage device(s) 306 may store instructions associated with cost prediction system 104, query system 316, training system 318, CLP system 108, and UI system 320. Additionally, storage device(s) 306 may store a healthcare graph database 312 and a training set database 314. Cost prediction system 104 includes machine learning model 106. Storage device(s) 306 may include any suitable storage medium for storing information related to user graph data, training sets for machine learning techniques, parameters derived as a result of training a machine learning system, search results, and source data that may be used by cost prediction system 104 to generate an estimated healthcare cost. Although illustrated here for simplicity as separate components within provider computing system 102, components within storage devices 306, such as healthcare graph database 312 and cost prediction training data 328, may be remote (e.g., cloud storage) and accessed using communication unit(s) 310 over a network (e.g., network 120 of FIG. 1) or local within a single component such as provider storage system 110.

Healthcare graph database 312 stores a healthcare graph. The healthcare graph comprises nodes and edges that represent information related to healthcare of a population of users. For example, the healthcare graph may include nodes corresponding to individual users, nodes corresponding to insurance claims, nodes corresponding medical services, nodes corresponding to medicines, nodes corresponding to healthcare providers, nodes corresponding to medical diagnoses, nodes corresponding to prescription drugs, and so on. The edges of the healthcare graph are directed edges and indicate relationships between nodes. For example, an edge between a node corresponding to a user and a node corresponding to a medical diagnosis may indicate the user has received the medical diagnosis. In another example, an edge between a node for a user and a node for an insurance claim may indicate that the insurance claim was filed for the user. Multiple edges of the healthcare graph may lead to the same node. For instance, edges from nodes for multiple users may lead to a node for a specific medical diagnosis or a node for a specific hospital. Thus, even though many users may have the same medical diagnosis, the healthcare graph does not need to include multiple nodes for the medical diagnosis. This reuse of nodes for multiple users may make the healthcare graph an especially efficient way of storing information related to the healthcare of multiple users.

Prior to or during a process to generate an estimated healthcare cost of a user, query system 316 may extract a user subgraph of the user from healthcare graph database 312. The user subgraph of the user comprises nodes and edges that represent information associated with medical care of the user. In some examples, the user subgraph of the user may include nodes and edges that represent other information, such as demographic information of the user. As part of extracting the user subgraph of the user from healthcare graph database 312, query system 316 may traverse the healthcare graph stored in healthcare graph database 312 to identify nodes and edges that provide information associated with the medical care of the user and/or other information about the user. For example, query system 316 may start a traversal of the healthcare graph from a node corresponding to the user and follow edges from that node outward to other nodes, and follow edges from those nodes, and so on. The traversal may follow only specific types of edges in particular directions, so the traversal does not lead into nodes and edges that represent information associated with medical care of other users. The identified nodes and edges included in the user subgraph may be the nodes and edges of the healthcare graph that query system 316 reaches in the traversal.

Cost prediction system 104 may apply machine learning model 106 to generate, based on the user subgraph, an estimated healthcare cost of the user for a future time period. The estimated healthcare cost of the user for the future time period is an amount of money that the user may expect to spend out of pocket on healthcare during the future time period. In some examples, machine learning model 106 may generate the estimated healthcare cost of the user based on other information, such as demographic information 206 (FIG. 2).

As shown in the example of FIG. 3, machine learning model 106 may include a graph neural network (GNN) 324 and a feed-forward neural network (FFNN) 326. Cost prediction system 104 may apply GNN 324 to generate a medical embedding based on the user subgraph (e.g., user subgraph 200). Cost prediction system 104 may concatenate the medical embedding generated by GNN 324 to a demographic embedding to create a user embedding. Cost prediction system 104 may generate the demographic embedding from demographic information (e.g., demographic information 206 of FIG. 2) in the user subgraph. Embeddings are numerical representations of real-world objects and relationships, expressed as a vector. The vector space may quantify the semantic similarity between categories. Some examples for creating an embedding may include using one or more techniques such as one-hot encoding (e.g., for gender), normalization, and vectorized Federal Information Processing Standards (FIPS) code (e.g., node2vec to FIPS data), among others. In the example of FIG. 3, the medical embedding and demographic embedding include numerical representations of medical information and demographic information associated with the user (member).

As mentioned above, cost prediction system 104 may apply GNN 324 may generate a medical embedding based on a medical subgraph of the user. The medical subgraph of the user is a portion of the user subgraph of the user. In some examples, the medical subgraph of the user is the same as the user subgraph of the user. In other examples, the medical subgraph of the user excludes certain data in the user subgraph of the user, such as demographic information.

Each node of the medical subgraph of the user is associated with a vector comprising numerical values. At the start of the process of applying GNN 324 to generate the medical embedding, the numerical values in the vector of a node provide information describing the node. For example, a first numerical value in a vector of a node associated with an insurance claim may provide information about a date of the insurance claim, a second numerical value in the value of the node may provide information about a total cost of the insurance claim, and so on. As part of applying GNN 324, cost prediction system 104 may perform one or more rounds of message passing. During each round of message passing, cost prediction system 104 may exchange the vectors of nodes with vectors of neighboring nodes. The neighboring nodes of a node are nodes that are connected to the node via edges. After collecting the vectors of the neighboring nodes of the node, cost prediction system 104 may perform an aggregation process that generates an aggregated vector for the node by aggregating the vectors of the neighboring nodes and the vector of the node. The aggregation process may generate numerical values in the aggregated vector for the node based on a sum of corresponding numerical values in the vectors of the neighboring nodes and the vector of the node.

After generating an aggregated vector for the node, cost prediction system 104 may apply a neural network (NN) to generate an output vector (i.e., a NN-output vector) for the node based on the aggregated vector. In some examples, the neural network is a fully-connected network that includes one or more hidden layers. In some examples, the neural network is a multi-layer perceptron having one input layer, one hidden layer, and one output layer. A Rectified Linear Unit (ReLU) activation function may be used in the neural network. In some examples, the neural network is a convolutional neural network. The NN-output vector for the node may be a vector comprising one or more numerical elements. The number of numerical elements in the NN-output vector for the node may be the same or different from the number of numerical elements in the aggregated vector of the node. Cost prediction system 104 may generate NN-output vectors for each node of the user subgraph. The NN-output vectors of the nodes may serve as the vectors of the nodes for the next round of message passing. Cost prediction system 104 may use different neural networks in different rounds of message passing. The medical embedding is the NN-output vector for one of the nodes (e.g., a node associated with the user). As indicated above, cost prediction system 104 may concatenate the medical embedding with a demographic embedding to form a user embedding.

In the example of FIG. 3, cost prediction system 104 applies FFNN 326 to generate an estimated healthcare cost for the user based on the user embedding. FFNN 326 may be a fully-connected neural network having one or more hidden layers. Cost prediction system 104 may determine the estimated healthcare costs based on output of an output layer of FFNN 326. In some examples, the output layer of FFNN 326 includes neurons corresponding to different monetary ranges. For instance, a first neuron may correspond to a range of $0-200, a second neuron may correspond to a range of $201-$400, and so on. For each neuron of the output layer, the values generated by the neuron may be a confidence value indicating a level of confidence that the estimated healthcare cost for the user is in the monetary range corresponding to the neuron. Cost prediction system 104 may determine the estimated healthcare costs as being in the monetary range corresponding to the neuron that generated the greatest confidence value.

UI system 320 generates a user interface including the estimated healthcare cost and additional elements, some of which are provided by constraint logic programming (CLP) system 108. In one example, CLP system 108 includes an application programming interface (API) 309 that generates medical spending options that may be presented to the user based on constraints such as a total amount the user (member) is anticipated to spend on healthcare, medical expense categories, and costs based on factors such as region. API 309 may connect various components (e.g., UI system 320, CLP system 108, etc.) and include a set of CLP functions for implementing techniques of the disclosure. CLP functions of API 309 may be configured to receive input from cost prediction system 104, healthcare graph database 312 and UI system 320 to determine spending options based on one or more constraints (e.g., categories of spending, budget amount, etc.). CLP system 108 and medical expense categories are further described with respect to example user interfaces described in FIGS. 4A-4C.

FIGS. 4A-4C illustrate an example user interface 400 generated for display on a user device. User interface 400 of FIG. 4A when displayed includes an estimated healthcare cost field 402, available expense field 404, a selected expense field 406, and a budget field 408. Available expense field 404 includes available expense elements 405A-405F (collectively, “available expense elements 405”). In one example, available expense elements 405 of user interface 400 correspond to medical expense categories. The medical expense categories may include prescription-related expenses, medical expenses, allergy-related expenses, vision-related expenses, maternity-related expenses, dental-related expenses, and so on.

In one example, estimated healthcare cost field 402 indicates the estimated healthcare cost generated by cost prediction system 104. Budget field 408 indicates a healthcare budget. In one example, UI system 320 automatically populates the estimated healthcare cost into budget field 408. In another example, UI system 320 may receive an indication of user input into budget field 408, that may be more or less than the estimated healthcare cost from estimated healthcare cost field 402. For example, a user may anticipate a cost, such as a maternity cost, that may not be predicted by cost prediction system 104 and adjust the budget amount indicated in budget field 408 accordingly. UI system 320 may receive an indication of user input from the list of available expense field 404 indicating which of the medical expenses to prioritize for the budget amount in budget field 408. For example, the indication received may include medical expense element 410 and allergy/OTC expense element 412. In one example, UI system 320 receives the indication when the expense elements are inputted (e.g., mouse drag) into selected expense field 406. UI system 320 may be configured such that the position of each selected expense in selected expense field 406 provides an indication of ranking of each selected expense. The medical expense categories may be ranked based on importance to the health of the user. For example, a top-down ranking of expenses such that the highest priority expense is in the top slot (e.g., medical expense element 410) and the next highest below that (e.g., allergy/OTC expense element 412) and so on.

In the example of FIG. 4A, the user has entered a lower dollar amount in budget field 408 than the estimated healthcare cost indicated in estimated healthcare cost field 402. CLP system 108 may determine the amount entered is too low based on comparing the total of an estimated cost for the selected medical expense element 410 and allergy/OTC expense element 412 to budget field 408. In one example, UI system 320 updates user interface 400 to display an indicator 414 that indicates that the amount in budget field 408 is too low for the healthcare expense categories in selected expense field 406.

In one example, CLP system 108 checks the sufficiency of the amount in budget field 408 by comparing selected medical expense categories of selected expense field 406 to the amount in budget field 408. For example, the highest priority medical expense category (e.g., top of selected expense field 406) is compared to the amount in budget field 408. If there is sufficient budget for that medical expense category then any remaining budget is compared to the next highest priority medical expense category. This process continues until the amount in budget field 408 is no longer sufficient for the selected medical expense category or there are no additional medical expense categories to compare. UI system 320 may update user interface 400 to indicate which medical expense categories of expense field 406 are covered by the amount in budget field 408 and which of the medical expense categories are not covered by the amount in budget field 408. In another example, when the budget is too low for the selected subset, CLP system 108 may determine an amount of additional budget required to add to budget field 408 to cover the cost of the selected medical expense categories. UI system 320 may update user interface 400 to display the amount of additional budget. Based on a determination that the aggregate cost is less than or equal to the updated budget, UI system 320 may update user interface 400 to indicate the aggregate cost of the subset is less than or equal to the updated budget.

FIG. 4B illustrates a budget amount entered in budget field 408 that satisfies the user's selection of medical expense element 410 and allergy/OTC expense element 412. Further, the budget amount is high enough for CLP system 108 to generate options 416 from available expense field 404 that covers the amount in budget field 408, as shown by a checkmark by indicator 414. In one example, options 416 are one or more recommendations generated by CLP system 108 that include different subsets of the selectable list of available expense field 404. The selected expenses associated with each of options 416 are generated by CLP system 108 to satisfy the applied constraints, such as the amount in budget field 408 and ranking of the selected expenses for each option of options 416. In other words, CLP system 108 may apply one or more constraints associated with each medical expense category and the budget and ranking of each medical expense category according to a set of constraint logic programming (CLP) functions as discussed above with respect to the example of API 309 of FIG. 3. API 309 may generate costs in one or more of the categories based on a moving average of costs over a time period and based on a per health referral region basis. For example, API 309 of CLP system 108 may dynamically generate or look up a cost for a baby/maternity medical expense category related to labor and delivery in a region (e.g., city or state) over a time period. The cost may be based on an average across all members in healthcare graph database 312 that have received labor and delivery services within a configurable time period.

In the example of FIG. 4B, option 0 of options 416 represents an initial indication and ranking of medical expense element 410 and allergy/OTC expense element 412 from available expense field 404. FIG. 4C illustrates a generated user interface 400 displaying a selection of option 2 of options 416. In one example, CLP system 108 has generated option 2, along with options 1 and 3, based on one or more of the constraints discussed above. In this example, CLP system 108 has ranked and generated a subset of available expenses that fit within the available budget indicated in budget field 408. The subset of available expenses as shown in selected expense field 406 includes prescription expense 418 at the highest rank, medical expense 420 at the next highest rank, and dental expense 422 at the lowest rank. Options 1 and 3 (not shown) may include subsets of different available medical expenses that similarly are ranked and may be covered by the amount in budget field 408. In one example, CLP system 108 may receive an indication of a modification of an option in options 416, such as switching out an expense category or changing the rank of the expenses by changing the order within the selected expense field 406 of user interface 400. In response to the modification of the option, CLP system 108 may determine if the budget is sufficient to cover the modified option. An indicator 414 may indicate whether the budget is sufficient to cover the modified option. In some examples, if the budget is not sufficient to cover the modified option, CLP system 108 may determine, based on the ranking of each expense, which of the expenses can be covered given the budget.

Thus, in some examples, CLP system 108 may receive an indication of a selection of a subset of the one or more selectable medical expense categories and determine an aggregate cost of the subset is less than or equal to the budget. CLP system 108 may determine additional subsets of the selectable medical expense categories that have aggregate costs that are less than or equal to the budget. UI system 320 may update the user interface to include selectable options corresponding to the additional subsets of the selectable medical expense categories.

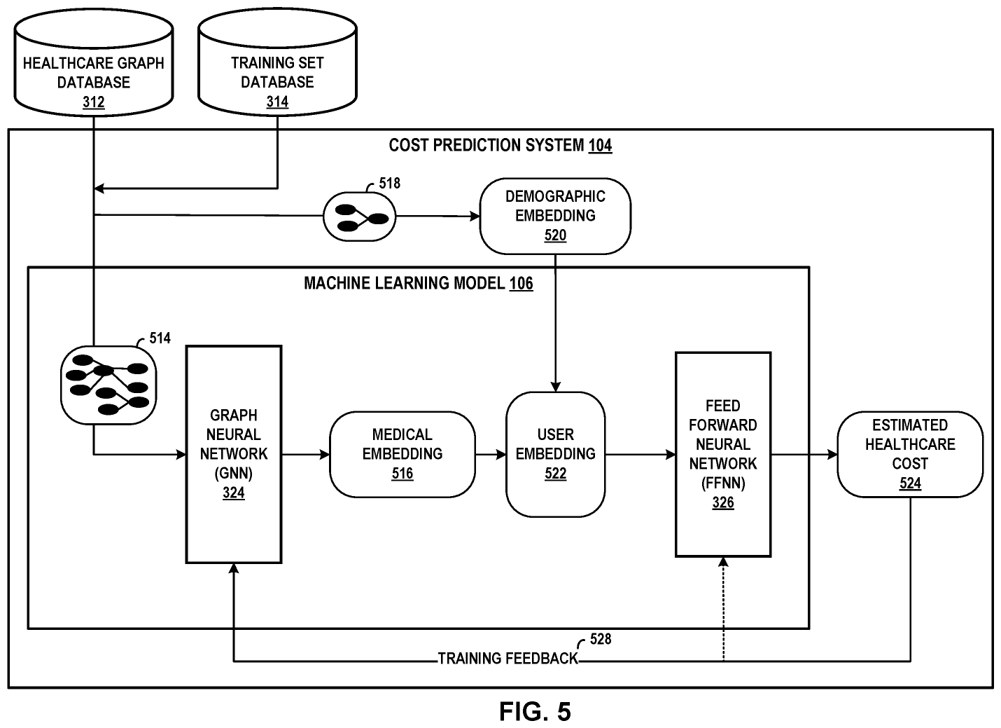

FIG. 5 is an example of training machine learning 106 to generate an estimated healthcare cost in accordance with techniques of the disclosure. Cost prediction system 104 may be implemented, in whole or in part, by components of provider computing system 102 of FIGS. 1 and 3. In one example, cost prediction system 104 includes training set database 314. Training set database 314 may store training data used to machine learning model 106, which includes GNN 324 and FFNN 326. For example, the training data may include one or more training datasets for supervised training. Training system 318 may generate the training datasets in part by extracting user subgraphs for users from healthcare graph database 312.

In one example, cost prediction system 104 provides training datasets stored in training set database 314 to machine learning model 106. Cost prediction system 104, for each dataset, divides the user graph data into medical graph data 514 and a demographic graph data 518, as discussed above with respect to FIG. 3. Cost prediction system 104 may convert demographic graph data 518 into demographic embedding 520 and GNN 324 of cost prediction system 104 may receive medical graph data 514 and generate medical embedding 516. Cost prediction system 104 may concatenate medical embedding 516 and demographic embedding 520 to create user embedding 522. User embedding 522 is a tensor that cost prediction system 104 provides as input to cost prediction model 508. As shown in the example of FIG. 5, cost prediction model 508 includes FFNN 326. The output of FFNN 326 is an estimated healthcare cost (e.g., estimated healthcare cost 524) corresponding to user embedding 522.

In one example, during training, training system 318 uses training feedback 528 to adjust parameters (e.g., weights and offsets) of GNN 324 and FFNN 326. During training, training system 318 may obtain one or more training datasets. Training set database 314 may store the training datasets. Each training dataset includes input-output pairs. The input of an input-output pair may include a medical subgraph of a user and a demographic embedding of the user. The output of the input-output pair includes a ground-truth healthcare cost of the user. For instance, the medical subgraph and demographic embedding of the input-output pair may provide information about a specific user and the ground-truth healthcare cost may indicate an amount that the specific user actually spent on healthcare during a time period. Training system 318 may apply GNN 324 and FFNN 326 to the input of the input-output pair to generate a value corresponding to the estimated healthcare cost. Training system 318 may apply a loss function (e.g., cross entropy loss function) that generates a loss value based on the estimated healthcare cost generated by FFNN 326 and the ground truth healthcare cost of the input-output pair. Training system 318 may use the loss value to perform a backpropagation process that may update parameters in FFNN 326 and GNN 324. In some examples, training system 318 may generate an average loss value based on loss values generated based on the input-output pairs in a training dataset. Training system 318 may use the average loss value to perform the backpropagation process. In examples where multiple rounds of message passing are performed when generating the medical embedding (and therefore multiple neural networks may be applied), the backpropagation process may treat the neural networks as being concatenated with each other. The backpropagation process may operate on a principle of gradient descent and thus may modifying the parameters in a direction that reduces the loss value.

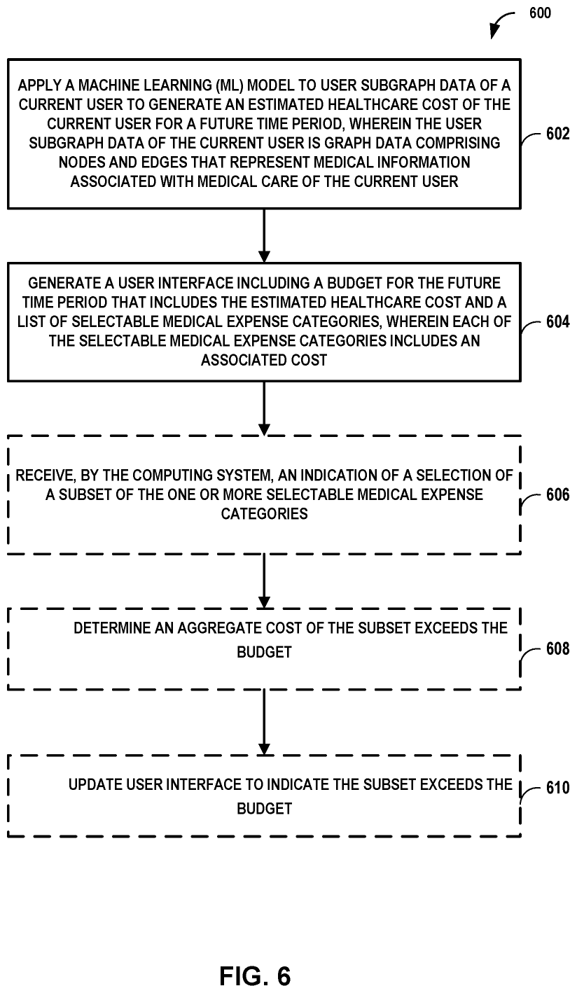

FIG. 6 is a flow diagram illustrating example operations performed by provider computing system 102 in accordance with one or more aspects of the present disclosure. FIG. 6 is described below within the context of computing system 100 and provider computing system 102 of FIGS. 1 and 3. In other examples, operations described in FIG. 6 may be performed by one or more other components, modules, systems, or devices. Further, in other examples, operations described in connection with FIG. 6 may be merged, performed in a different sequence, omitted, or may encompass additional operations not specifically illustrated or described.

Provider computing system 102 may apply a ML model (e.g., ML model 106) to a user subgraph (e.g., user subgraph 200) of a current user to generate an estimated healthcare cost (e.g., estimated healthcare cost field 402 and estimated healthcare cost 524) of the current user for a future time period. In one example, the user subgraph of the current user is graph data comprising nodes and edges (e.g., nodes and edges of user subgraph 200) that represent information associated with medical care of the current user (602). Provider computing system 102 may generate the user subgraph by processing a query that may be initiated by provider computing system 102 or originate from a user device. For example, query system 316 may process the query to generate the user subgraph from a medical graph. In one example, machine learning model 104 includes a graph neural network (e.g., GNN 324) and a feed-forward neural network (e.g., 326).

Provider computing system 102 may generate a user interface (e.g., user interface 400) for display on a user device (e.g., one of user devices 122). The user interface includes display elements and budget information (e.g., budget field 408) for the future time period. In one example, budget information and display elements include the estimated healthcare cost and a list of selectable medical expense categories (e.g., available expense field 404) (604). Each of the selectable medical expense categories includes an associated cost. The medical expense categories may include prescription-related expenses, medical expenses, allergy-related expenses, vision-related expenses, maternity-related expenses, dental-related expenses, and so on.

Additionally, provider computing system 102 may receive, by the computing system, an indication of a selection of a subset of the one or more selectable medical expense categories (e.g., selected expense field 406) (606). In one example, an indication of the selection comes from a user device, such as user device 122A. Provider computing system 102, based on the indication of the selection of the subset, determines an aggregate cost of the subset exceeds the budget (608) and updates the user interface to indicate the subset exceeds the budget (e.g., indicator 414) (610).

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

For ease of illustration, a limited number of devices or modules (e.g., cost prediction system 104, 104 and 502, ML models 106, CLP system 108, user devices 122A to N, query system 316, CLP system 108, and UI system 320, processors 304, as well as others) are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

In one or more examples, the functions described may be implemented in hardware, software, firmware, or any combination thereof. If implemented in software, the functions may be stored on or transmitted over a computer-readable medium as one or more instructions or code and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM, or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, microcontrollers, FPGAs, or other equivalent integrated or discrete logic circuitry, as well as any combination of such components. Accordingly, the term “processor,” as used herein, may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless communication device or wireless handset, a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method for estimating healthcare costs, the method comprising:
applying, by a computing system, a machine learning (ML) model to a user subgraph of a current user to generate an estimated healthcare cost of the current user for a future time period, wherein the user subgraph of the current user is graph data comprising nodes and edges that represent information associated with medical care of the current user; and
generating, by the computing system, a user interface including a budget for the future time period that includes the estimated healthcare cost and a list of selectable medical expense categories, wherein each of the selectable medical expense categories includes an associated cost.

2. The method of claim 1, wherein applying the ML model comprises:
generating a demographic embedding based on a first portion of the user subgraph of the current user;
applying a graph neural network to generate a medical embedding of the current user based on a second portion of the user subgraph of the current user; and
applying a feed forward neural network to generate the estimated healthcare cost based on a user embedding of the current user that includes the demographic embedding of the current user and the medical embedding of the current user.

3. The method of claim 1, further comprising training the ML model based on one or more training datasets, wherein:
for each respective training dataset of the plurality of training datasets:
the respective training dataset includes a plurality of input-output pairs,
for each respective input-output pair of the plurality of input-output pairs:
the input of the respective input-output pair includes a user subgraph of a respective user in a population of users, wherein the user subgraph of the respective user is a graph that includes nodes and edges representing medical information of the respective user,
the input of the respective input-output pair further includes a demographic embedding associated with the user, wherein the demographic embedding includes demographic data representing non-medical information of the respective user, and
the output of the respective input-output pair indicates a ground-truth healthcare cost of the respective user.

4. The method of claim 1, further comprising performing, by the computing system, a traversal of a healthcare graph to generate the user subgraph, wherein the healthcare graph includes nodes and edges representing information related to healthcare of a population of users.

5. The method of claim 1, the method further comprising:
receiving, by the computing system, an indication of a selection of a subset of the one or more selectable medical expense categories;
determining an aggregate cost of the subset exceeds the budget; and
updating the user interface to indicate the subset exceeds the budget.

6. The method of claim 5, wherein each of the selectable medical expense categories has a rank based on importance to health of the current user and the method further comprising:
aggregating each medical expense category starting with lowest ranking medical expense category until the aggregate cost of the remaining higher ranking medical expense categories are less than or equal to the budget; and
updating the user interface to indicate which medical expense categories of the subset exceed the budget and which medical expense categories of the subset are less than or equal to the budget.

7. The method of claim 5, further comprising:
receiving, by the computing system, an updated budget, wherein the updated budget is an increase to the budget;
determining the aggregate cost of the subset is less than or equal to the updated budget; and
updating the user interface to indicate the aggregate cost of the subset is less than or equal to the updated budget.

8. The method of claim 1, further comprising:
receiving, by the computing system, an indication of a selection of a subset of the one or more selectable medical expense categories;
determining an aggregate cost of the subset is less than or equal to the budget;
determining additional subsets of the selectable medical expense categories that have aggregate costs that are less than or equal to the budget; and
updating the user interface to include selectable options corresponding to the additional subsets of the selectable medical expense categories.

9. The method of claim 8, wherein determining the additional subsets of the selectable medical expense categories that have aggregate costs that are less than or equal to the budget comprises applying one or more constraints associated with each medical expense category and the budget and ranking of each medical expense category according to a set of constraint logic programming functions.

10. A system comprising:
a storage device; and
processing circuitry having access to the storage device and configured to:
apply a machine learning (ML) model to a user subgraph of a current user to generate an estimated healthcare cost of the current user for a future time period, wherein the user subgraph of the current user is graph data comprising nodes and edges that represent information associated with medical care of the current user; and
generate a user interface including a budget for the future time period that includes the estimated healthcare cost and a list of selectable medical expense categories, wherein each of the selectable medical expense categories includes an associated cost.

11. The system of claim 10, wherein to apply the ML model the processing circuitry configured to:
generate a demographic embedding based on a first portion of the user subgraph of the current user;
apply a graph neural network to generate a medical embedding of the current user based on a second portion of the user subgraph of the current user; and
apply a feed forward neural network to generate the estimated healthcare cost based on a user embedding of the current user that includes the demographic embedding of the current user and the medical embedding of the current user.

12. The system of claim 10, the processing circuitry is configured to train the ML model based on a plurality of training datasets, wherein:
for each respective training dataset of the plurality of training datasets:
the respective training dataset includes a plurality of input-output pairs,
for each respective input-output pair of the plurality of input-output pairs:
the input of the respective input-output pair includes a user subgraph of a respective user in a population of users, wherein the user subgraph of the respective user is a graph that includes nodes and edges representing medical information of the respective user,
the input data of the respective input-output pair further includes a demographic embedding associated with the user, wherein the demographic embedding includes demographic data representing non-medical information of the respective user, and
the output data of the respective input-output pair indicates an estimated healthcare cost of the respective user.

13. The system of claim 10, wherein the processing circuitry is further configured to perform a traversal of a healthcare graph to generate the user subgraph, wherein the healthcare graph includes nodes and edges representing information related to healthcare of a population of users.

14. The system of claim 10, wherein the processing circuitry is configured to:
receive an indication of a selection of a subset of the one or more selectable medical expense categories;
determine an aggregate cost of the subset exceeds the budget; and
update the user interface to indicate the subset exceeds the budget.

15. The system of claim 14, wherein each of the selectable medical expense categories has a rank based on importance to health of the current user and the processing circuitry is further configured to:
aggregate each medical expense category starting with lowest ranking medical expense category until the aggregate cost of the remaining higher ranking medical expense categories are less than or equal to the budget; and
update the user interface to indicate which medical expense categories of the subset exceed the budget and which medical expense categories of the subset are less than or equal to the budget.

16. The system of claim 14, wherein the processing circuitry is further configured to:
receive an updated budget, wherein the updated budget is an increase to the budget;
determine the aggregate cost of the subset is less than or equal to the updated budget; and
update the user interface to indicate the aggregate cost of the subset is less than or equal to the updated budget.

17. The system of claim 10, wherein the processing circuitry is further configured to:
receive an indication of a selection of a subset of the one or more selectable medical expense categories;
determine an aggregate cost of the subset is less than or equal to the budget;
determine additional subsets of the selectable medical expense categories that have aggregate costs that are less than or equal to the budget; and
update the user interface to include selectable options corresponding to the additional subsets of the selectable medical expense categories.

18. A non-transitory computer-readable storage medium comprising instructions that, when executed, cause processing circuitry of a computing system to:
apply a machine learning (ML) model to user subgraph of a current user to generate an estimated healthcare cost of the current user for a future time period, wherein the user subgraph of the current user is graph data comprising nodes and edges that represent information associated with medical care of the current user; and
generate a user interface including a budget for the future time period that includes the estimated healthcare cost and a list of selectable medical expense categories, wherein each of the selectable medical expense categories includes an associated cost.

19. The non-transitory computer-readable storage medium of claim 18, wherein the instructions that cause the processing circuitry to apply the ML model comprise instructions that, when executed, cause the processing circuitry to:
generate a demographic embedding based on a first portion of the user subgraph of the current user;
apply a graph neural network to generate a medical embedding of the current user based on a second portion of the user subgraph of the current user; and
apply a feed forward neural network to generate the estimated healthcare cost based on a user embedding of the current user that includes the demographic embedding of the current user and the medical embedding of the current user.

20. The non-transitory computer-readable storage medium of claim 18, further comprising instructions that, when executed, cause the processing circuitry to perform a traversal of a healthcare graph to generate the user subgraph, wherein the healthcare graph includes nodes and edges representing information related to healthcare of a population of users.
